(19) United States
(12) Patent Application Publication
(10) Pub. No.: US 2014/0328431 A1
(43) Pub. Date: Nov. 6, 2014

(54) CREST FACTOR REDUCTION FOR FREQUENCY HOPPING MODULATION SCHEMES AND FOR HARDWARE ACCELERATION OF WIDEBAND AND DYNAMIC FREQUENCY SYSTEMS IN A WIRELESS NETWORK

(71) Applicant: SAMSUNG ELECTRONICS CO., LTD., Suwon-si (KR)

(72) Inventors: Khalil Haddad, Allen, TX (US); Breck Wayne Lovinggood, Garland, TX (US)

(73) Assignee: Samsung Electronics Co., LTD., Suwon-si (KR)

(21) Appl. No.: 13/875,030

(22) Filed: May 1, 2013

(51) Int. Cl. H04L 25/03

(52) U.S. Cl. CPC H04L 25/03859
USPC 375/296

(57) ABSTRACT

A transmitter for use in a wireless communication network of frequency agile signals is provided. The transmitter includes a frequency hop (FH) machine. The FH machine includes a timing block configured to receive real time configuration information and generate real time timing signals for the FH machine. The FH machine also includes a real time hardware (RTHW) processor corresponding to at least one independent antenna path. The RTHW processor is configured to reconfigure a plurality of digital signal processing (DSP) blocks on a hop by hop basis using the received real time configuration information. The transmitter includes a composite crest factor reducer pulse shaping filter (CPSF) generator configured to dynamically generate and load a composite pulse shaping filter into a CPSF look up table together with an input signal inclusively within a frequency hopping period, on a hop by hop basis.

### TECHNICAL FIELD

The present application relates generally to wireless communication systems and, more specifically, to a crest factor reduction of frequency hopping signals.

### BACKGROUND

A Crest Factor Reduction (CFR) algorithm is based on a peak cancellation algorithm that does not support frequency hopping types of signals. Digital pre-distortion (DPD) can be used for multi-carrier Global System for Mobile Communications (GSM). For multi-carrier GSM the spectral emission requirement demands extremely high performance in the DPD. DPD architectures for multi-carrier GSM have advanced to where the spectral emission requirements can be met.

An existing DPD application-specific integrated circuit (ASIC) uses an external digital signal processor (ex-DSP) for handling the DPD calibration and training. Though this DPD ASIC ex-DSP solution works well for fixed frequency applications, this solution does not have the processing power to support both crest factor reduction and DPD in a frequency hopping environment. This DPD ASIC system performs all control, calibration, and hop by hop configuration with an external DSP processor. This approach is limited in capability due to both the limitations of the DPD ASIC itself and the control port bandwidth.

### SUMMARY

A method for use in a wireless communication network is provided. The method includes generating real time timing signals for a frequency hop (FH) machine using a received ARFCN signal and received timing signal. The method also includes reconfiguring, by a real time hardware processor, a plurality of digital signal processing (DSP) blocks on a hop by hop basis. The DPS blocks include a digital up converter (DUC), a digital down converter (DDC), and a crest factor reducer (CFR). The method further includes configuring look up tables in a digital-pre-distortion (DPD) block on a hop by hop basis using the received timing signals.

A composite crest factor reducer pulse shaping filter (CPSF) generator for use in a wireless communication system is provided. The CPSF generator includes a plurality of instructions stored in a computer-readable medium, the plurality of instructions configured to, when executed, cause processing circuitry to perform certain processes. The processes include: dynamically generate a composite pulse shaping filter (PSF) corresponding to a frequency hopping input signal received by a crest factor reducer (CFR); and load the composite PSF into a PSF look up table (LUT) of the CFR. The CPSF generator is configured to dynamically generate and load the composite PSF into the CFR PSF LUT inclusively within a frequency hopping period T. The CPSF generator is also configured to load the composite PSF into the CFR PSF LUT together with the input signal.

A frequency hop (FH) machine for use in a wireless communication network of frequency agile signals is provided. The frequency hop (FH) machine includes a timing block configured to receive real time configuration information, such as an ARFCN signal and a timing signal. The timing block also generates real time timing signals for the FH machine. The FH machine includes a real time hardware (RTHW) processor corresponding at least one independent antenna paths. The FH machine reconfigures a plurality of digital signal processing (DSP) blocks on a hop by hop basis. The RTHW processor also configures look up tables in the digital-pre-distortion (DPD) block on a hop by hop basis using the received real time configuration information.

A transmitter for use in a wireless communication network of frequency agile signals is provided. The transmitter includes a frequency hop (FH) machine. The FH machine includes a timing block configured to receive real time configuration information and generate real time timing signals for the FH machine. The FH machine also includes a real time hardware (RTHW) processor corresponding to at least one independent antenna path. The RTHW processor is configured to reconfigure a plurality of digital signal processing (DSP) blocks on a hop by hop basis using the received real time configuration information.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless network according to embodiments of the present disclosure;

FIG. 2 illustrates a waveform of a wireless signal according to the present disclosure;

FIG. 3 illustrates a basic structure of the peak cancellation algorithm for a Crest Factor Reduction (CFR) that according to embodiments of the present disclosure;

FIG. 4 illustrates a composite CFR Pulse shaping filter generator (CPSF generator) as implemented in hardware for generating a composite pulse shaping filter according to embodiments of the present disclosure;

FIG. 5 illustrates a DPD ASIC ex-DSP that performs DPD and CFR and that supports a multi-mode operation which includes frequency hopping GSM according to the present disclosure;

FIG. 6 illustrates a single chip integrating the separate ICs of the DPD ASIC ex-DSP of FIG. 5;

FIG. 7 illustrates a transceiver implemented in a system that includes frequency agile signals according to embodiments of the present disclosure;

FIG. 8 illustrates a Multi-mode GSM Remote Radio Head (RRH) transceiver in a high level system diagram according to embodiments of the present disclosure;

FIG. 9 illustrates a single transmit path in a system within a RRH transceiver of FIG. 8 according to embodiments of the present disclosure;

FIG. 10 illustrates a GSM FH Machine implementing a RTHW processor function according to embodiments of the present disclosure;

FIGS. 11 and 12 illustrate a timing diagram the complex system within a transceiver according to embodiments of the present disclosure; and

FIG. 13 illustrates a high level process 1300 flow implemented by the DPD NIOS 820 (also referred to as “DPD processor”) according to embodiments of the present disclosure.

### DETAILED DESCRIPTION

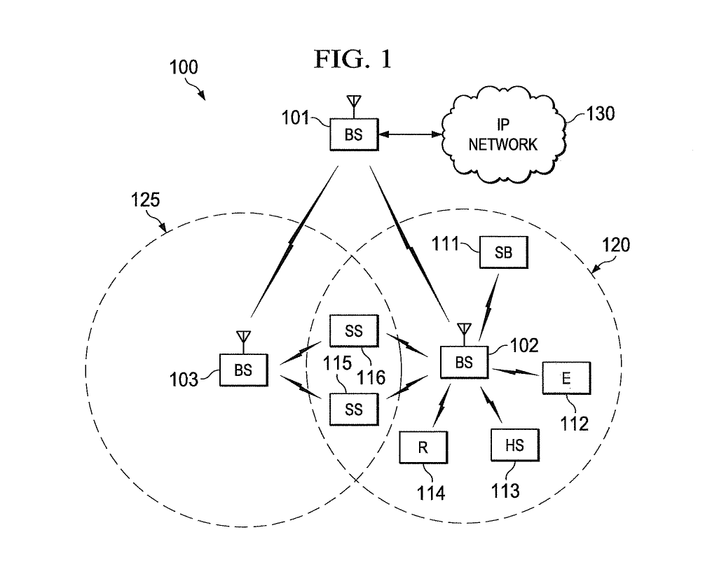

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

There is a need in the art for a multi-mode Remote Radio Head (RRH) product that supports frequency hopped GSM together with other modes, such as Wideband Code Division Multiple Access (WCDMA) and Long-Term Evolution (LTE). The key challenge in the multi-mode RRH product is to provide multi-carrier digital up and down conversion, crest factor reduction (CFR), and digital pre-distortion (DPD) functions to ensure optimal cost, efficiency, and spectral emissions performance of the RRH. In this development process no solution was found that could meet the requirements of the multi-mode RRH product. This is due to some unique aspects of the two key signal processing blocks to address frequency hopped GSM. These are the crest factor reduction (CFR) and digital pre-distortion (DPD) blocks.

Crest factor reduction (CFR) is an algorithm that reduces the output peak to average ratio while controlling the in-band noise and the out-of-band spectral growth. In-band noise degrades the error vector magnitude (EVM) performance, and out-of-band noise impacts the spectral emission performance. The challenge in a frequency hop system is that the CFR filter coefficients must change each time the system hops to a new set of frequencies. That is, the CFR filter coefficients must change on a hop-by-hop basis. Multiple methods are used to accomplish this. In one method, a complete new set of coefficients are calculated and downloaded to the CFR on a hop by hop basis. The present disclosure provides a different method and hardware implementation to compute and update the CFR filter coefficients.

The spectral emission requirements for a multi carrier GSM (MC-GSM) transmitter are very demanding and require an extremely high performance DPD. This is a significant challenge in a frequency hopping system because the “optimal” set of coefficients for a DPD change on a hop by hop basis. As a result, a unique set of DPD coefficients corresponding to each possible set of hopping frequencies is required. These coefficients are loaded into the DPD on a hop by hop basis.

The requirements of configuring the CFR and DPD on a hop by hop basis create a significant overhead for a system such as the DPD ASIC ex-DSP. The ex-DSP processor must not only configure the CFR and DPD on a hop by hop basis, the ex-DSP must also process feedback data and calculate new sets of DPD coefficients continuously in order to ensure that the transmitter continues to meet the EVM and spectral emission requirements as conditions change. There are numerous factors that can impact the transmitter performance including temperature, aging, signal power changes, power supply changes, and antenna impedance changes. The ex-DPD must continue to adapt the coefficient sets over time to ensure high quality transmissions.

Embodiments of the present disclosure provide a multi-carrier GSM system that handles the frequency hopping aspects of GSM. A base station transmitter includes a composite crest factor reducer pulse shaping filter (CPSF) generator for use in a wireless communication system. The CPSF generator includes code stored in a computer-readable medium, the code configured to, when executed, cause processing circuitry to perform certain functions. Those certain functions including dynamically generate a composite pulse shaping filter (PSF) corresponding to a frequency hopping input signal received by a crest factor reducer (CFR); and load the composite PSF into a PSF look up table (LUT) of the CFR; and dynamically generate and load the composite PSF into the CFR PSF LUT inclusively within a frequency hopping period T. The composite PSF is loaded into the CFR PSF LUT together with the input signal.

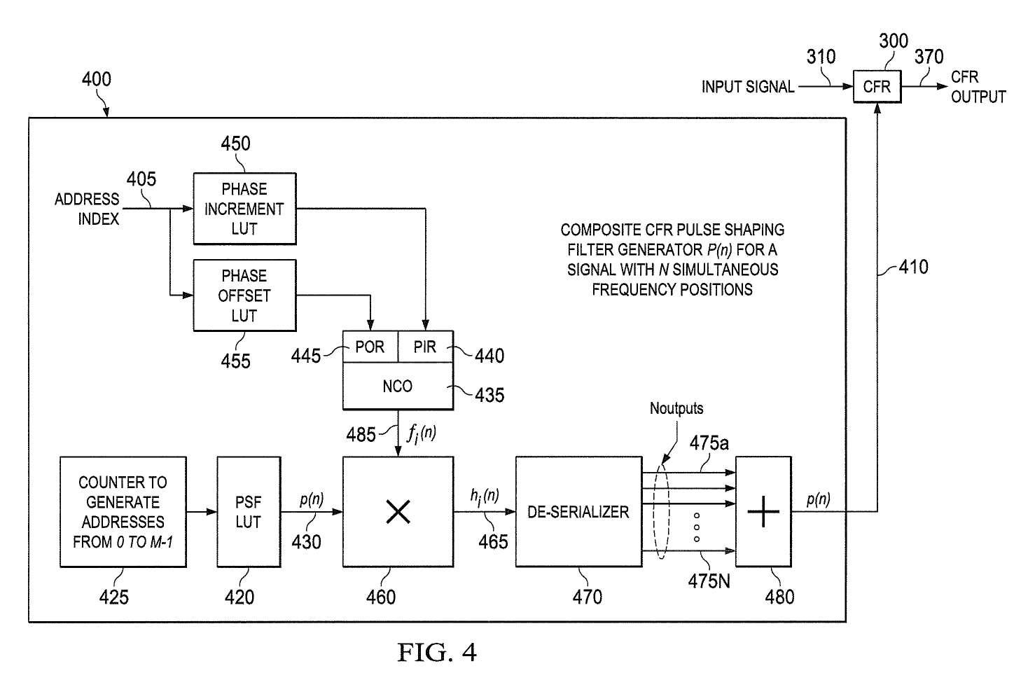

Certain embodiments of the present disclosure include method and apparatus for implementing a cost effective, high performance frequency hop GSM transmitter. The CFR 300 of FIG. 3 further improves the performance of the method and apparatus for implementing a cost effective, high performance frequency hop GSM transmitter.

FIG. 1 illustrates a wireless network 100 according to one embodiment of the present disclosure. The embodiment of wireless network 100 illustrated in FIG. 1 is for illustration only. Other embodiments of wireless network 100 could be used without departing from the scope of this disclosure.

The wireless network 100 includes eNodeB (eNB) 101, eNB 102, and eNB 103. The eNB 101 communicates with eNB 102 and eNB 103. The eNB 101 also communicates with Internet protocol (IP) network 130, such as the Internet, a proprietary IP network, or other data network.

Depending on the network type, other well-known terms may be used instead of “eNodeB,” such as “base station” or “access point”. For the sake of convenience, the term “eNodeB” shall be used herein to refer to the network infrastructure components that provide wireless access to remote terminals. In addition, the term user equipment (UE) is used herein to refer to remote terminals that can be used by a consumer to access services via the wireless communications network. Other well know terms for the remote terminals include “mobile stations” and “subscriber stations.”

The eNB 102 provides wireless broadband access to network 130 to a first plurality of user equipments (UEs) within coverage area 120 of eNB 102. The first plurality of UEs includes UE 111, which may be located in a small business; UE 112, which may be located in an enterprise; UE 113, which may be located in a WiFi hotspot; UE 114, which may be located in a first residence; UE 115, which may be located in a second residence; and UE 116, which may be a mobile device, such as a cell phone, a wireless laptop, a wireless PDA, or the like. UEs 111-116 may be any wireless communication device, such as, but not limited to, a mobile phone, mobile PDA and any mobile station (MS).

For the sake of convenience, the term “user equipment” or “UE” is used herein to designate any remote wireless equipment that wirelessly accesses an eNB, whether the UE is a mobile device (e.g., cell phone) or is normally considered a stationary device (e.g., desktop personal computer, vending machine, etc.). In other systems, other well-known terms may be used instead of “user equipment”, such as “mobile station” (MS), “subscriber station” (SS), “remote terminal” (RT), “wireless terminal” (WT), and the like.

The eNB 103 provides wireless broadband access to a second plurality of UEs within coverage area 125 of eNB 103. The second plurality of UEs includes UE 115 and UE 116. In some embodiment, one or more of eNBs 101-103 may communicate with each other and with UEs 111-116 using LTE or LTE-A techniques including techniques for implementing a high performance frequency hop GSM transmitter described in embodiments of the present disclosure.

Dotted lines show the approximate extents of coverage areas 120 and 125, which are shown as approximately circular for the purposes of illustration and explanation only. It should be clearly understood that the coverage areas associated with base stations, for example, coverage areas 120 and 125, may have other shapes, including irregular shapes, depending upon the configuration of the base stations and variations in the radio environment associated with natural and man-made obstructions.

Although FIG. 1 depicts one example of a wireless network 100, various changes may be made to FIG. 1. For example, another type of data network, such as a wired network, may be substituted for wireless network 100. In a wired network, network terminals may replace eNBs 101-103 and UEs 111-116. Wired connections may replace the wireless connections depicted in FIG. 1.

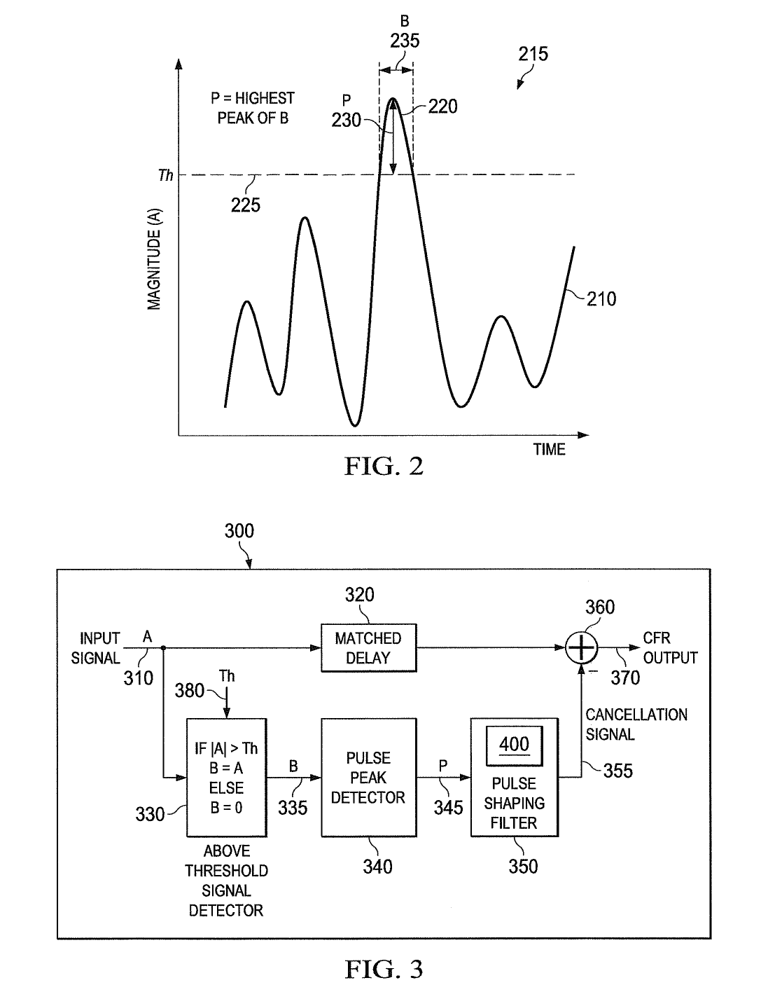

FIG. 2 illustrates a waveform 210 of a wireless signal, such as a wireless signal transmitted from a base station 101. A graph 215 of the waveform 210 includes the magnitude of the wireless signal on the vertical axis and time on the horizontal axis. The crest 220 of the waveform 210 is the portion of the waveform that is higher than a threshold magnitude 225. The highest magnitude of the wireless signal occurs during a time period 235 (B), which is the time period when the magnitude of the wireless signal is greater than the threshold magnitude 225. The peak 230 (P) of the wireless signal is the height of the crest 220. That is, the difference in magnitude between the threshold magnitude 225 and the highest magnitude of the wireless signal is the peak 230 (P).

FIG. 3 illustrates a basic structure of the peak cancellation algorithm for a Crest Factor Reduction (CFR) 300 that according to embodiments of the present disclosure. The embodiment of the CFR 300 shown in FIG. 3 is for illustration only. Other embodiments could be used without departing from the scope of this disclosure. For example, the CFR 300 700 can be implemented in a transmitter, such as a transmitter within a transceiver, and base station 102.

Certain embodiments of provide a method to reduce the peak to average power ratio (PAPR) or the crest factor reduction (CFR) of the transmitted waveform for frequency hopping signals, such as Global System for Mobile Communications (GSM) signals and Enhanced Data rates for GSM Evolution (EDGE) signals.

The CFR 300 preconditions the signal by reducing the signal peaks below a certain pre-defined threshold 225 while controlling the amount of distortion of the signal. The CFR 300 allows a power amplifier to operate with less back-off and with higher efficiency, thereby saving power and cost. The CFR 300 also supplements the digital predistortion algorithm and improves its effectiveness. The CFR 300 and the implemented algorithm provide important benefits in the radio transmitter by extending the CFR 300 capabilities to frequency hopping types of signals.

The CFR 300 removes or cancels the peaks of the input signal 310 that exceed a certain defined threshold (Th) 380. The cancellation is performed by subtracting from the input signal stream, a user-designed, spectrally shaped cancellation pulses generated by the logic blocks within the CFR 300.

The logic blocks of the CFR 300 include a matched delay 320, an above-threshold signal detector 330, a pulse peak detector 340, a pulse shaping filter 350, and a subtractor 360. The CFR 300 receives an input signal 310 into the matched delay 320 and the above-threshold signal detector 330. The matched delay 320 outputs the input signal 310 to the subtractor 360 after a delay period. In certain embodiments, the delay period is substantially the same amount of time consumed by processing the input signal 310 through the series of the above-threshold signal detector 330, pulse peak detector 340, and pulse shaping filter 350.

The above-threshold signal detector 330 outputs a crest signal 335 (B). The crest signal 335 is the part of the input signal 310 that is greater than the threshold (Th) 380. In certain embodiments, the above-threshold signal detector 330 determines the threshold 380 by receiving a signal indicating the level of magnitude of the threshold 380. In certain embodiments, the above-threshold signal detector 330 stores a value of the threshold 380. The level or the value of the threshold 380 can be represented on a graph, such as by the threshold magnitude 225.

The above-threshold signal detector 330 generates the crest signal 335 based on a comparison of the input signal 310 to the threshold 380. For example, the above-threshold signal detector 330 compares an absolute value of the input signal 310 to the threshold 380. If the input signal (or the absolute value of the input signal) is greater than the threshold 380, then the above-threshold signal detector 330 determines that the crest signal 335 is the same as the input signal 310 (A) and generates the crest signal 335 accordingly. Alternatively, if the input signal (or the absolute value of the input signal) is equal to or less than the threshold 380, then the above-threshold signal detector 330 determines that the crest signal 335 has a value of zero and generates the zero-value crest signal 335 accordingly.

The pulse peak detector 340 computes and outputs the peak of the pulse signal (B), which is shown as the peak 230 (P) in FIG. 2. That is, pulse peak detector 340 computes the peak (P) of the crest signal 335 (B) and outputs the pulse signal 345 (P). That is, the pulse peak detector 340 receives the crest signal 335, computes the value of the peak 230 (P) of the received crest signal 335 (B), and outputs the pulse signal 345 (P).

The pulse shaping filter 350 (PSF) contains a finite impulse response filter configured to spectrally shape the correction signal 355 to be compatible with the spectrum of the input signal so that the corrected output signal 370 will comply with the spectral mask and error vector magnitude (EVM) specifications. The output of the PSF 350 is the cancellation signal 355.

The subtractor 360 (also referred to as an adder) subtracts the cancellation signal from the input signal 310, thereby generating and outputting the CFR 300 output signal 370. The cancellation signal 355 and the input signal 310 must be time aligned so the subtraction can reduce the peaks of the signal to below the desired threshold (Th) 380. As described above, the matched delay 320 delays forwarding the input signal 310 to the subtractor 360.

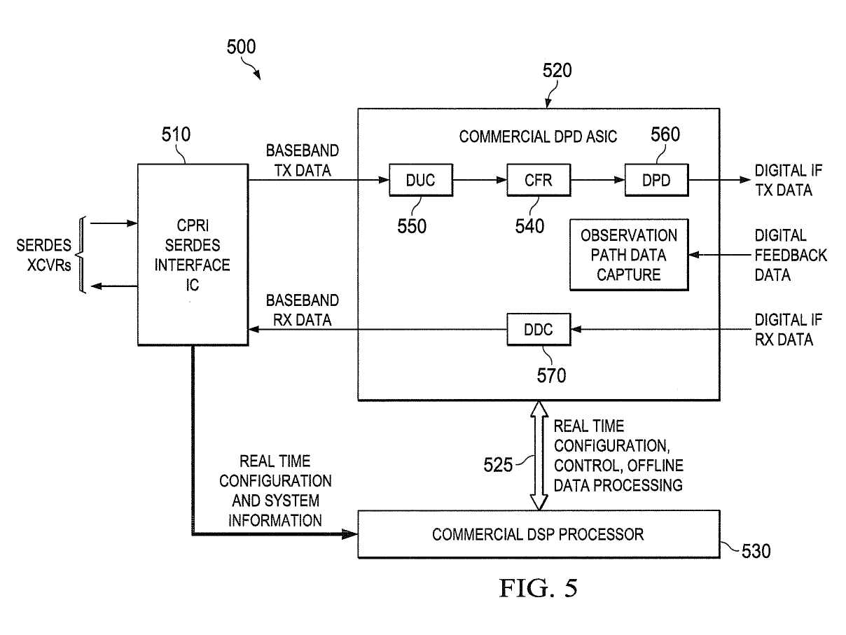

FIG. 4 illustrates a composite CFR Pulse shaping filter generator 400 (CPSF generator) as implemented in hardware for generating the composite PSF 410, herein also referred to as the function p(n). The CPSF generator 400 performs well in the wideband multi-mode Remote Radio Unit (RRU). In certain embodiments, the CPSF generator 400 is part of the radio transmitter. In certain embodiments, the CPSF generator 400 is implemented in a Field Programmable Gate Array (FPGA) and operates in conjunction with a digital pre-distortion unit to support multicarrier and frequency hopping signals such as GSM signals and EDGE signals. Although certain details will be provided with reference to the components of the CPSF generator 400, it should be understood that other embodiments may include more, less, or different components. In certain embodiments, the CFR 300 includes the CPSF generator 400, such as included within the PSF 350. In certain embodiments, the CPSF generator 400 is coupled to the CFR 300, such as communicably coupled by sending the output of the CPSF generator 400 to the PSF 350 of the CFR 300 or by receiving a signal from the CFR 300.

In order for the CFR 300 to support frequency hopping signals, the CFR PSF 350 is dynamically updated when the input signal 310 changes frequency, as in frequency hopping signals. The CPSF generator 400 receives information indicating the frequencies to be included in a signal to be transmitted. Based on those frequencies, the CPSF generator 400 generates coefficients to be used in the CFR PSF 350. If frequency hopping occurs periodically, every T seconds, then the CPSF generator 400 dynamically computes and loads the composite PSF 410 to the CFR PSF 350 look up table (LUT) in a period of less than or equal than T seconds in tandem (for example, at substantially the same time) with the hopping frequency of the input signal 310. Under the circumstance that the hopping period is T seconds, the computation of the composite PSF 410 must be completed and ready to be loaded to the CFR 300 before the next hop. Usually, the composite PSF 410 is loaded to the CFR 300 during a time gap when the transmitted signal is silent.

The PSF LUT block 420 stores a pre-computed symmetrical finite impulse response (FIR) filter of size M. The modulo M counter block 425 generates a sequence of numbers (0 to M−1) to address the PSF LUT 420 that generates the baseband PSF 430 p(n).

The digital numerically controlled oscillator 435 (NCO) is associated with two main registers: the phase increment register 440 (PIR) and the phase offset register 445 (POR). In certain embodiments, the NCO 435 includes the main registers 445 and 440. Each of the POR 445 and PIR 440 can be a set of N registers if the input hopping signal of the CFR contains N different frequencies. The registers from both sets configure the NCO 435 in an alternate fashion to generate a serial sequence composed of multiplexed multi-tones each with a specific frequency and phase offset. In certain embodiments, the POR 445 and PIR 440 are coupled to the NCO 435. The main registers 440, 445 are configured every T seconds, where T seconds represents the period of the hopping transmitted signal. The PIR 440 and POR 445 are configured from the data stored in the phase increment LUT 450 (PIL) and the phase offset LUT 455 (POL), respectively. That is, an address index signal 405 indicates to the PIL 450 a phase increment value to be sent to the PIR 440. For example, the address index signal 405 indicates an address (within the PIL 450) of the phase increment value to be sent from the PIL 450 to the PIR 440. The address index signal 405 indicates to the POL 455 a phase offset value to be sent to the POR 445. For example, the address index signal 405 indicates an address (within the POL 455) of the phase offset value to be sent from the POL 455 to the POR 445. The PIR 440 and POR 445 configure the NCO 435 to output a complex signal f(n) for single frequency or fᵢ(n) 485 for i=1 . . . N for multiple N frequencies, each with a specific phase offset. The complex signal f(n) includes real and imaginary parts. The PIR 440 configures the NCO 435 to output the complex signal f(n) with a specific frequency. The POR 445 configures the NCO 435 to output the complex signal f(n) with a specific phase. After the PIR 440 and POR 445 are loaded with new values the NCO 435 is enabled to run. The size of the baseband PSF 430 is limited to M, as a result, only the first M outputs fᵢ(n) 485 are considered. The data in the POL 455 and PIL 450 are computed based on the baseband PSF length size M, the sampling frequency, and the hopping frequencies of the transmitted signal. The data in POL 455 and PIL 450 are pre-computed to insure that the set of complex output tones f(n) for n=1 . . . M and i=1 . . . N are symmetrical. In the multiplier 460, baseband PSF 430 p(n) is multiplied by the complex signal f(n) in order to up-convert the baseband PSF 430 from a baseband signal to a passband signal represented by hᵢ(n) of Equation 1:

hᵢ(n)=p(n)*fᵢ(n) for n=1 . . . M (1)

That is, hᵢ(n) represents the passband PSF 465, which is a sequence.

Under the circumstance that the complex signals f(n) and p(n) are symmetrical, then h(n) will also be symmetrical, satisfying the properties of symmetry represented by equations 2 and 3:

$$\begin{matrix}h ( k ) = {h}^{*} ( M - k + 1 ) \\ for k = 1 … M and M is odd & ( 2 ) \\ h ( \frac{M + 1}{2} ) = 1 + 0 j \\ for k - 1 … M and M is odd & ( 3 )\end{matrix}$$

For the case where the transmitted signal contains multiple N hopping frequencies, the generated PSF 410 is a composite PSF. That is, the generated composite PSF 410 is the sum of N baseband PSFs 430 generated for each of the N frequencies. In certain embodiments, the NCO 435 generates multiple N different tones fᵢ(n) 485 where n=1 . . . M and i=1 . . . N multiplexed in an alternate fashion. Such as: f₁(1), f₂(1) . . . f_{N}(1), f₁(2), f₂(2), . . . , F_{N}(2), f₁(3), f₂(3), . . . f_{N}(3), . . . f₁(M), f₂(M) . . . f_{N}(M).

In the case where N=2, for example, the POR 445 and PIR 440 of the NCO 435 are each configured with two different values in order to generate f₁(n) and f₂(n), respectively. The POR 445 and PIR 440 receive their values from POL 455 and PIL 450 respectively.

To perform the up-conversion, the multiplier 460 multiplies each of f₁(n) and f₂(n) by p(n). The multiplier output data sequence is: p(1)*f₁(1), p(1)*f₂(1), p(2)*f₁(2), p(2)*f₂(2), . . . p(M−1)*f₁(M−1), p(M)*f₂ (M).

The de-serializer 470 receives the data sequence output from the multiplier 460 and de-multiplexes the sequence into two outputs or, in the case of N different frequencies, the de-serializer 470 outputs N outputs 475a-475N (where 475a represents the first of N outputs, and 475N represents the Nth of N outputs h₁ᵢ(n) where i=1 . . . N, such as:

$$\begin{matrix}{h}_{1} ( n ) = p ( n ) * {f}_{1} ( n ) for n = 1 … M . \\ {h}_{2} ( n ) = p ( n ) * {f}_{2} ( n ) for n = 1 … M . \\ ⋮ \\ {h}_{N} ( n ) = p ( n ) * {f}_{N} ( n ) for n = 1 … M .\end{matrix}$$

The adder block 480 will combine the de-serializer 470 outputs to produce the final composite PSF 410: P(n)=h₁(n)+h₂(n) for two outputs and in general for N outputs: P(n)=Σᵢ₌₁^{N}hᵢ(n) for n=1 . . . M.

P(n) will also satisfy the following properties of symmetry:

$$P ( k ) = {P}^{*} ( M - k + 1 )$$

$$for k = 1 … M$$

$$P ( \frac{M + 1}{2} ) = 1 + 0 j$$

$$for k = 1 … M$$

After P(n) is computed, it is loaded and stored in the CFR PSF 350 dedicated LUT 420. Updating the CFR PSF LUT 420 is done dynamically and periodically (every T seconds), usually during the guard time of the signal, when the signal power is low.

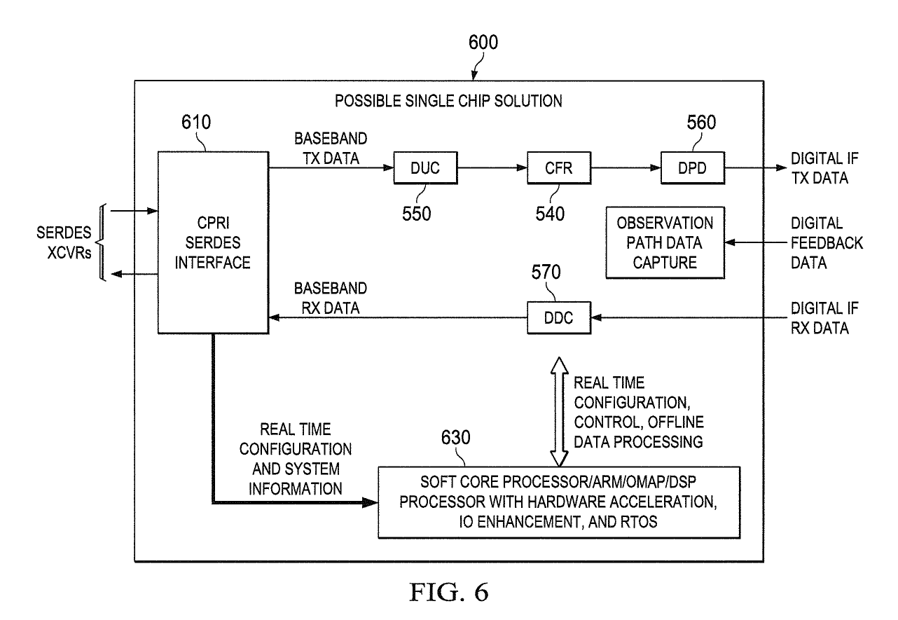

FIG. 5 illustrates a DPD ASIC ex-DSP 500 that performs DPD and CFR and that supports a multi-mode operation which includes frequency hopping GSM according to embodiments of the present disclosure. The embodiment of the DPD ASIC ex-DSP 500 shown in FIG. 5 is for illustration only. The DPD ASIC ex-DSP does not meet the full array of requirements for the product being developed.

The DPD ASIC ex-DSP 500 requires separate integrated circuits (ICs) to implement the Common Public Radio Interface (CPRI) Serializer-Deserializer (SERDES) interface 510, the DPD ASIC 520, and the DSP processor 530. The DPD ASIC 520 integrated circuit includes a CFR 540, digital up converter (DUC) 550, digital-pre-distortion (DPD) 560, and digital down converter (DDC) 570. The DPD ASIC ex-DSP 500 requires a large amount of circuit board space, is expensive, and has performance limitations. The major limitation of the DPD ASIC ex-DSP 500 is driven by the speed of the interface 525 between the DPD ASIC 520 and the DSP processor 530. This speed limitation limits the amount of configuration that can be performed for the CFR 540, DUC 550, DPD 560, and DDC 570 on a hop by hop basis as required in frequency hopped GSM. In light of these limitations, the DPD ASIC ex-DSP 500 does not provide a solution that provides the performance, integration, and flexibility to meet all of the requirements.

The DSP processor 530 is configured to perform math functions, but not configured to perform control functions. Accordingly, in a GSM system, the frequency hops occur every 577 microseconds (μs), the DSP 530 does not have the capability to perform DPD functions and perform updates on a frequency hop-by frequency hop basis.

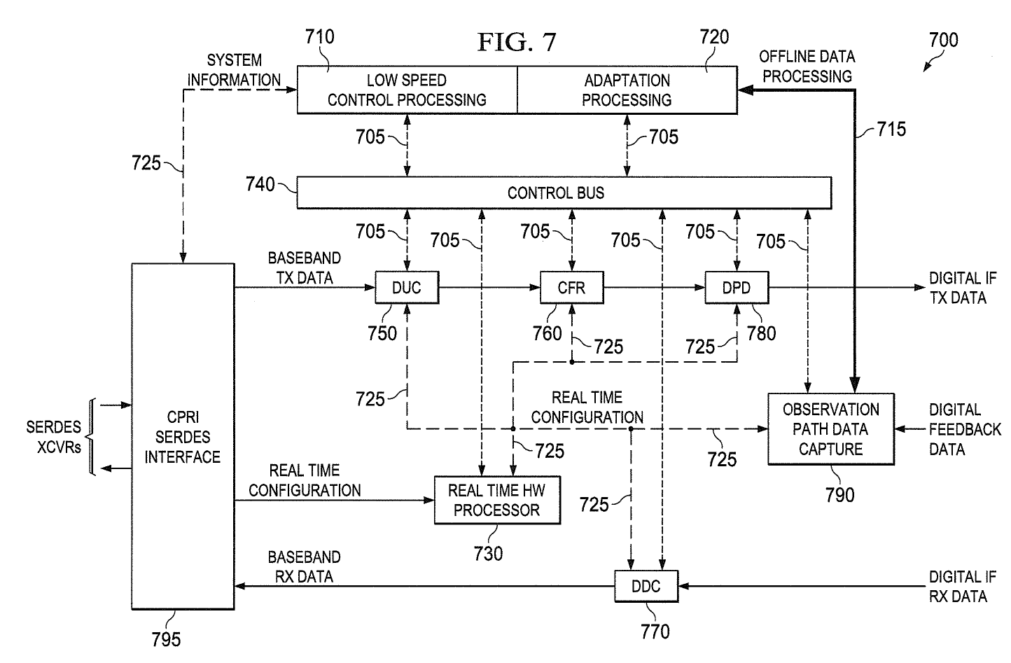

One approach to solving this problem is shown in FIG. 6. The cost and performance of FPGAs continues to improve with each advancing generation. FPGAs offer significant flexibility and the potential for integration. FIG. 6 illustrates a single chip 600 integrating the separate ICs of the DPD ASIC ex-DSP 500 of FIG. 5. Although certain details will be provided with reference to the components of the single chip 600, it should be understood that other embodiments may include more, less, or different components. The single chip 600 includes a CPRI SERDES interface 610 that performs the function of the CPRI SERDES interface 510. The single chip 600 includes the CFR 540, digital up converter (DUC) 550, digital-pre-distortion (DPD) 560, and the digital down converter (DDC) 570. The single chip 600 includes a soft core processor 630 that performs the function of the DSP processor 530.

Using a FPGA, a single chip 600 device can theoretically address the SERDES interface, hardware based DSP functions such as CFR, DUC, DDC, and DPD. In addition, by using soft core processors, FPGAs can implement the control and adaptation functions required. However, there are disadvantages. The soft core processors in the FPGA have a lower level of performance compared with the performance typically available in a dedicated DSP processor.

The single chip 600 implements a method to support a single chip implementation of the full digital transceiver including the SERDES transceivers, CFR, DUC, DDC, DPD, and control/adaptation processing that also meets the requirements for multi-mode operation which supports frequency hopped GSM.

In the single chip 600, all of the functions are incorporated into a single IC. In certain embodiments, the single chip 600 is implemented in a FPGA utilizing softcore processors. In certain embodiments, the single chip 600 is implemented in an ASIC utilizing an Advanced Reduced instruction set computing Machines (ARM®), OMAP™, or DSP processor. However, all of these approaches require that the processors still handle all real time control and configuration of the CFR, DUC, DPD, and DDC for frequency hopping. One solution is to increase the processing power, input-output (IO) speed, and utilize additional IO in the internal processor. However, this solution increases the overall power consumption of the single chip 600.

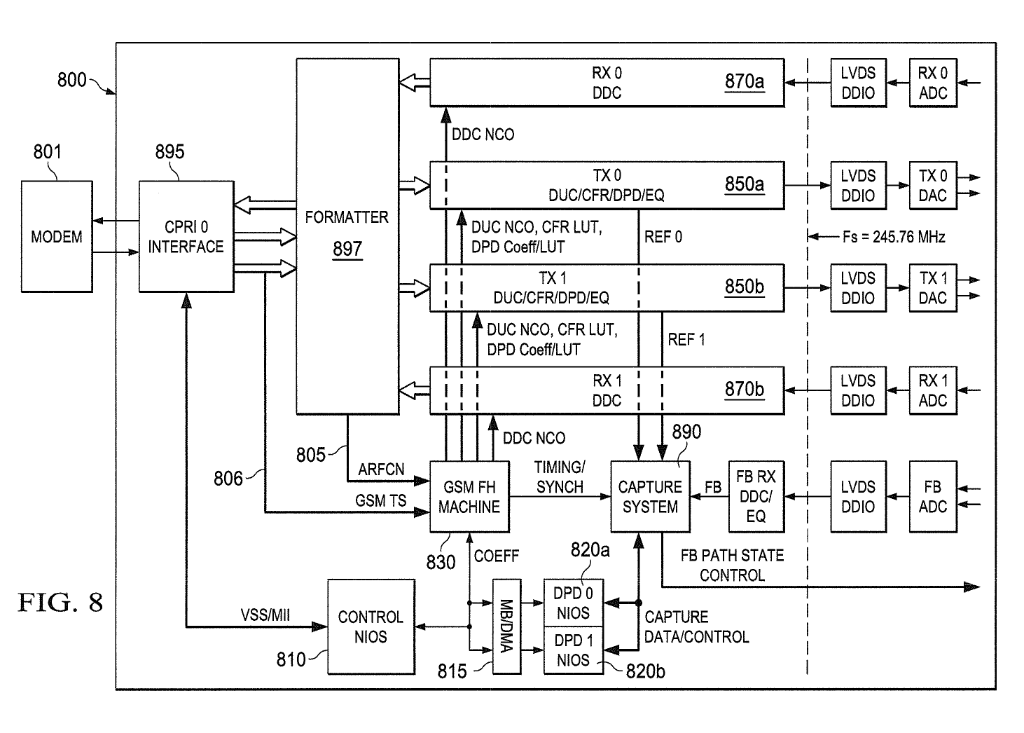

FIG. 7 illustrates a transceiver 700 implemented in a system that includes frequency agile signals according to embodiments of the present disclosure. For example, the transceiver 700 can be implemented in a base station 102. A high level diagram of an apparatus and methods according to the present disclosure is shown in FIG. 7, in which the processing requirements are distributed across both hardware specific functions and processor based software functions in order to reduce the operating speed of the hardware and the associated power implications along with reduced complexity in the processor core and peripherals which also reduces power consumption. An additional benefit is a significant reduction in code complexity and the elimination of the need for a real time operating system. As a result, the software is more reliable, the speed to market increases, and the memory requirements decrease. Although certain details will be provided with reference to the components of the transceiver 700, it should be understood that other embodiments may include more, less, or different components.

In the transceiver 700, the real time, control, and offline adaptation processing and interfaces are separate layers from each other to allow independent operation. This separation allows the processing hardware complexity and operating speed for each of these three functions to be optimized for the specific requirements of that implementation.

The control layer of the transceiver 700 includes a low speed control processor 710. The offline adaptation layer of the transceiver 700 includes an adaptation processor 720. The real time layer of the transceiver 700 includes a real time hardware processor 730. In certain embodiments, the control processor 710 is a simple microcontroller design operating at a low clock rate, and the adaptation processor 720 includes DSP specific hardware accelerators instantiated and operated at a much higher clock rate than the control processor 710. Depending on the requirements for a specific implementation, in certain embodiments, the control processor 720 and adaptation processer 720 are combined into one physical processor core, and in certain embodiments, the control processor 720 and adaptation processer 720 operate independently in separate processor cores. In the transceiver 700, the hardware resources and clock rates are tailored to the requirements of the specific application resulting in more optimal silicon costs and reduced power.

The transceiver 700 includes a control bus 740 configured to send control and data signals to and receive signals from (via control communication paths 705) the control processor 710, adaptation processor 720, the DUC 750, real time hardware processor 730, CFR 760, DDC 770, and DPD 780. In certain embodiments, the control bus 740 from the control processing function is configured to provide only initial configuration and setup parameters, such as initializing various setup parameters. Some examples of the initial configuration and setup parameters include look-up-tables, filter configurations, and filter coefficients.

The adaptation processing is typically an offline adaption (namely, non-real time). However, the time to process a single iteration of the adaptation process is often critical to overall system performance. Often a single adaptation processor 720 must adapt multiple DPD 780 solutions, including multiple transmit paths such as in MIMO applications. The adaptation processor 720 efficiently computes each of the adaptation solutions. To support this requirement, the transceiver 700 offloads all control and real time functions from the adaptation process. That is, the adaptation layer does not perform control layer functions or real time functions. The adaptation process only includes interfaces to the data capture 790 and the Real Time HW processor 730. For example, the adaptation processor 720 interfaces to the observation path data capture 790 via an adaptation communication path 715. The data capture block 790 provides actual signal data to the adaptation processor 720. The interface to the real time HW processor 730 allows the adaptation processor 720 to store a solution set to the real time HW processor 730.

The real time processing requirements have been completely isolated to a separate Real Time Hardware (RTHW) processor 730. RTHW processor 730 receives real time configuration information from the system within the transceiver 700 and uses this information to reconfigure each of the blocks on a hop by hop basis. For example, the RTHW processor 730 receives real time configuration information from the CPRI SERDES Interface 795, and uses this information to reconfigure the DUC 750, CFR 760, DDC 770, DPD 780, and observation path data capture 790. The RTHW processor 730 sends the reconfiguration information via real time communication paths 725. Examples of the key real time configuration data include actual frequency information, a hopping table index, or a hopping table offset along with the timing information related to the real time process. In certain embodiments, the real time configuration data includes the GSM absolute radio-frequency channel number (ARFCN) frequency values and the GSM time slot (TS) clock. For GSM, the system within the transceiver 700 is configured for hopping every 577 μs. The RTHW processor 730 converts the specific real time configuration information received into specific real time parameters for each of the blocks. For example, when the transceiver 700 is a GSM transceiver, the specific real time configuration information includes the DUC and DDC NCO frequencies, the CFR filter coefficients, and the DPD coefficients. In addition, the RTHW processor 730 supplies key control parameters to the data capture block 790. In certain embodiments, the key control parameters include the GSM time slot reference clock along with the index of the current hopping state.

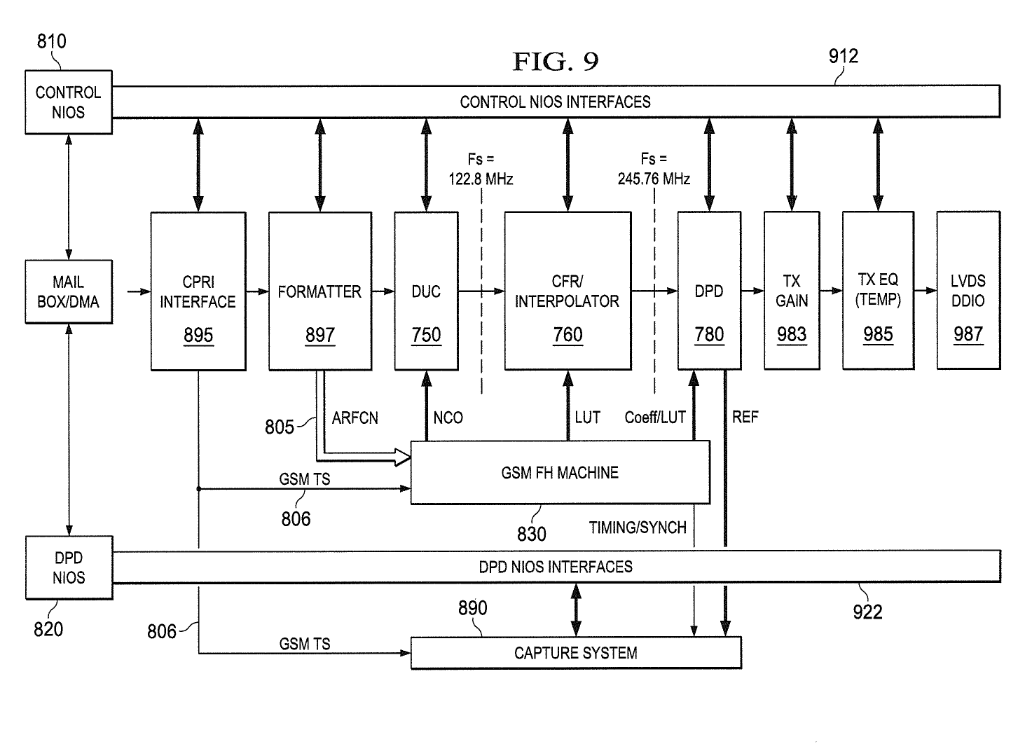

FIG. 8 illustrates a Multi-mode GSM Remote Radio Head (RRH) transceiver 800 in a high level system diagram according to embodiments of the present disclosure. The embodiment of the multi-mode RRH transceiver 800 shown in FIG. 8 is for illustration only. Other embodiments could be used without departing from the scope of this disclosure.

The RRH transceiver 800 supports multiple independent transmit and receive antenna paths. For example, as shown in FIG. 8, the RRH transceiver 800 supports two independent transmit and receive antenna paths. The first transmit path 850a, labeled “TX 0,” includes a DUC (for example, DUC 750), a CFR (for example, CFR 760), a DPD (for example, DPD 780, and an equalizer. The second transmit path 850b, labeled “TX 1,” includes a DUC (for example, DUC 750), a CFR (for example, CFR 760), a DPD (for example, DPD 780, and an equalizer. The first receive path 870a, labeled “RX 0,” includes a DDC (for example, DDC 770). The second receive path 870b, labeled “RX 1,” includes a DDC (for example, DDC 770).

The RRH transceiver 800 includes a primary interface, the CPRI interface 895 that carries the transmit and receive data between the modem unit 801 and the RRH 800. The CPRI interface 895 receives a GSM timing signal 806 from the modem 801 and forwards the timing signal 806 to the formatter 897 and to the GSM FH machine 830. In certain embodiments, the CPRI interface also forwards the timing signal 806 to the capture system 890. The CPRI interface 895 is associated with the formatter block 897 that converts the signal formats between the CPRI format and the specific format required for the Digital Up-Converter (DUC) 850a-b and the Digital Down-Converter (DDC) 870a-b. That is, the formatter 897 receives signals from a DDC 870 in the specific format required for the DDC 870, converts the signal to the CPRI format, and forwards the converted signal to the CPRI Interface 895. Similarly, the formatter 897 receives signals from the CPRI Interface 895 in the CPRI format, converts the signal to the specific format required for a DUC 850, and forwards the converted signal to the DUC 850. The formatter 897 sends an ARFCN signal 805 to the GSM FH machine 830.

The RRH transceiver 800 includes three NIOS softcore processors. The NIOS softcore processors are IP blocks supported in Altera FPGAs. One softcore processor is the low speed control processor 810, and the other two processors 820a-b perform the adaption of the digital pre-distortion blocks for both transmit paths 850a-b. The NIOS soft core processor 820a referred to as “DPD 0 NIOS” performs the adaption of the DPD for the first transmit path 850a. The NIOS soft core processor 820b referred to as “DPD 1 NIOS” performs the adaption of the DPD for the second transmit path 850b.

The RRH transceiver 800 includes the GSM flex-head (FH) machine 830 as the RTHW processor for the system within the RRH transceiver 800. The GSM FH machine 830 (herein also referred to as the “RTHW processor”) is configured to similar functions as the RTHW processor 730 previously described. This GSM FH hardware machine 830 handles the real time control of the oscillator frequencies in the up and down converters 850 and 870, in the CFR configuration on a hop by hop basis, and the DPD configuration on a hop by hop basis. The GSM FH machine 830 has direct access to the memory 815 of the Control NIOS 810 and both DPD NIOS 820a-b. For example, the memory 815 includes a memory block of direct memory access (MB/DMA). The GSM FH machine 830 stores coefficients in the memory 815. In certain embodiments, the GSM FH machine 830 receives the GSM timing signal 806 from the CPRI interface 895 and forwards the timing signal 806 along with synchronization information to the capture system 890.

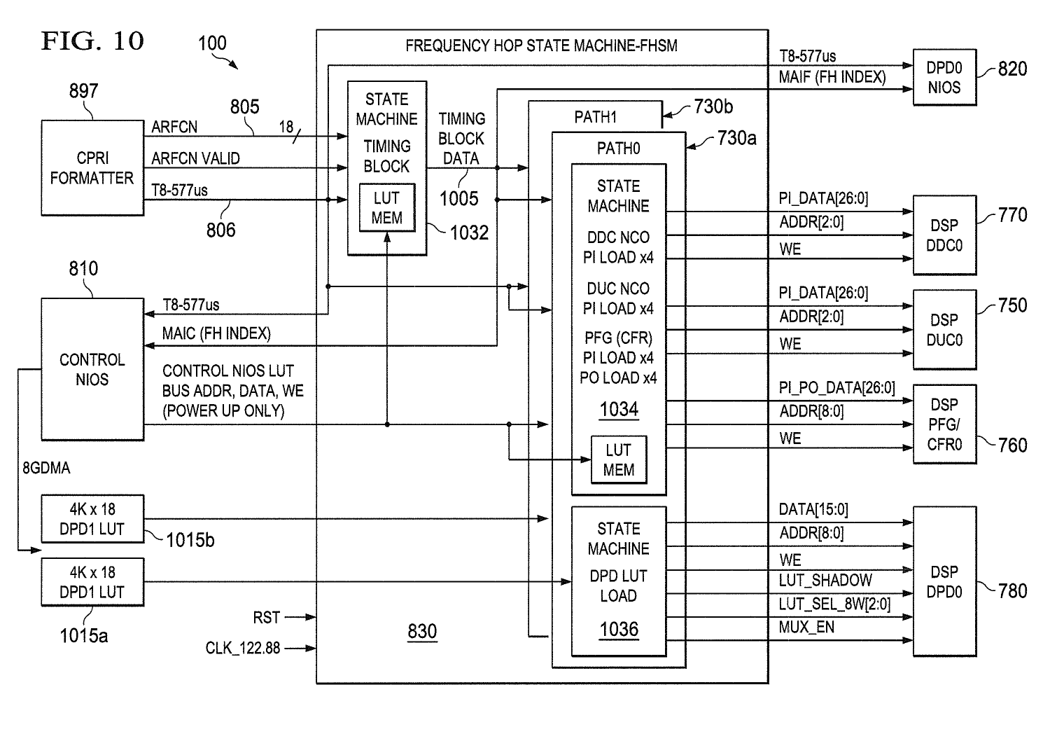

FIG. 9 illustrates a single transmit path 850 in a system within a RRH transceiver 800 of FIG. 8 according to embodiments of the present disclosure. More particularly, FIG. 9 provides detailed view of the hardware architecture, the interfaces, and the complex interaction between the GSM FH Machine real time HW processor 830 and the NIOS processors 810 and 820a-b for a single transmit path 850 in a system within a RRH transceiver 800. Although certain details will be provided with reference to the components of the single transmit path 850, it should be understood that other embodiments may include more, less, or different components. In certain embodiments of the present disclosure, the control processor 810 and the two DPD processors 820a-b are implemented using relatively low end processor cores because the functions of the real time layer are all processed using the RTHW processor 830.

The single transmit path 850 includes a DUC 750, a CFR/Interpolator 760, a DPD 780, and an equalizer 985. In certain embodiments, the transmit path includes a low voltage differential signaling (LVDS) direct data input/output 987 (LVDS DDIO). The control NIOS 810 includes one or more control NIOS interfaces 912. Also, the DPD NIOS 820 includes one or more DPD NIOS interfaces 922. As a comparison, the control NIOS interface 922 includes many communication paths, yet the DPD NIOS interface 922 includes few communication paths. For example, the control NIOS interface 922 communicates with the CPRI Interface 895, the formatter 897, DUC 750, CFR/Interpolator 760, DPD 780, transmit gain 983, and the equalizer 985, which is, together, at least seven communication paths. Alternatively, the DPD NIOS Interface 922 communicates with the capture system 890.

The GSM FH Machine 830 receives GSM timing signals (GSM TS) from the CPRI interface 895, and receives ARFCN signals from the formatter 897. The GSM FH Machine 830 sends NCO information to the DUC 750, sends LUT information to the CFR/Interpolator 760, and sends coefficients and LUT information to the DPD 780.

The capture system 890 receives GSM timing signals from the CPRI interface 895. The capture system 890 receives timing and synchronization signals from the GSM FH machine 830. The capture system 890 receives reference signals from the DPD 780. The capture system 890 sends signals to and receives signals from the DPD NIOS interface 922.

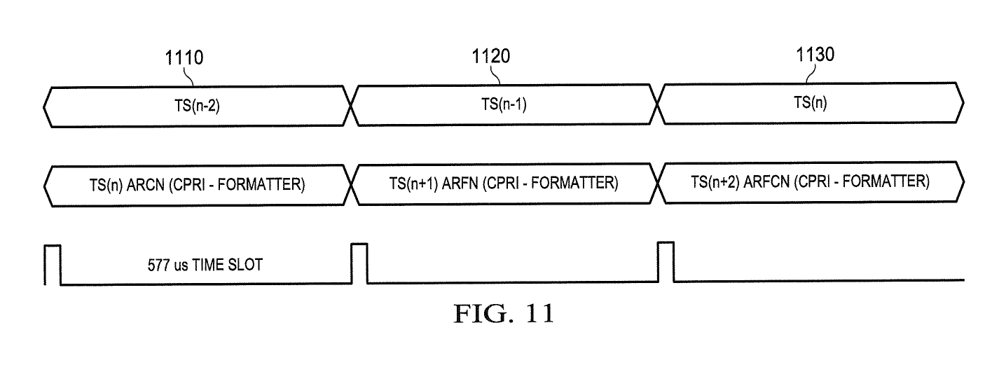

FIG. 10 illustrates a GSM FH Machine 830 implementing a RTHW processor function according to embodiments of the present disclosure. FIG. 10 provides an overview of the RTHW processor 830 functions. Although certain details will be provided with reference to the components of the GSM FH Machine 830, it should be understood that other embodiments may include more, less, or different components.

In certain embodiments, the real time HW processor 830 includes high speed state machines. In certain embodiments, the real time HW processor 830 includes any form of real time HW processing, including DSP specific techniques. As shown in FIG. 10, in certain embodiments, the real time HW processor 830 includes a Timing State Machine (TSM) 1032 configured to generate all of the real time timing signals required for this specific machine 830. The TSM 1032 receives an ARFCN signal from the CPRI formatter 897. In certain embodiments, the ARFCN signal includes 16 signals corresponding to eight GSM carriers for each of two antenna paths. The TSM 1032 receives a second signal from the CPRI formatter 897 indicating whether the ARFCN is valid. The TSM receives a third timing signal 806 from the CPRI formatter 897 indicating the length of the time slot. The TSM 1032 sends timing block data 1005 to the RTHW processor 730a of the first antenna path PATH0 and to the RTHW processor 730b of the second antenna path PATH1. The TSM 1032 sends the timing block data 1005 to the DPD NIOS 820, the Control NOIS 810.

The GSM FH machine 830 includes a separate HW processor 730a-b for each antenna path PATH0 and PATH1. For example, in order to support two independent antenna paths PATH0 and PATH1, a GSM FH machine 830 includes two RTHW processors 730a and 730b, and each RTHW processor includes two state machines. A first state machine 1034 computes the phase values for the NCOs in the digital up converter and for the digital down converter. The first state machine 1034 computes the filter coefficients for the crest factor reduction block. Each of these computations must occur on a hop by hop basis. In GSM, each hop period is approximately 577 μs.

The second state machine 1036 handles the configuration of the look up tables (LUTs) in the DPD block on a hop by hop basis: This processing is driven by the hop by hop frequency information received through the CPRI link 897.

The control NOIS 810 sends signals to the DPD LUT memory 815. That is, in certain embodiments, the memory 815 includes a plurality of look up tables, such as one DPD LUT 1015 associated with each RTHW processor 730. In particular, the memory 815 includes two look up tables: DPD LUT 1015a associated with each RTHW processor 730a, and DPD LUT 1015b associated with each RTHW processor 730b.

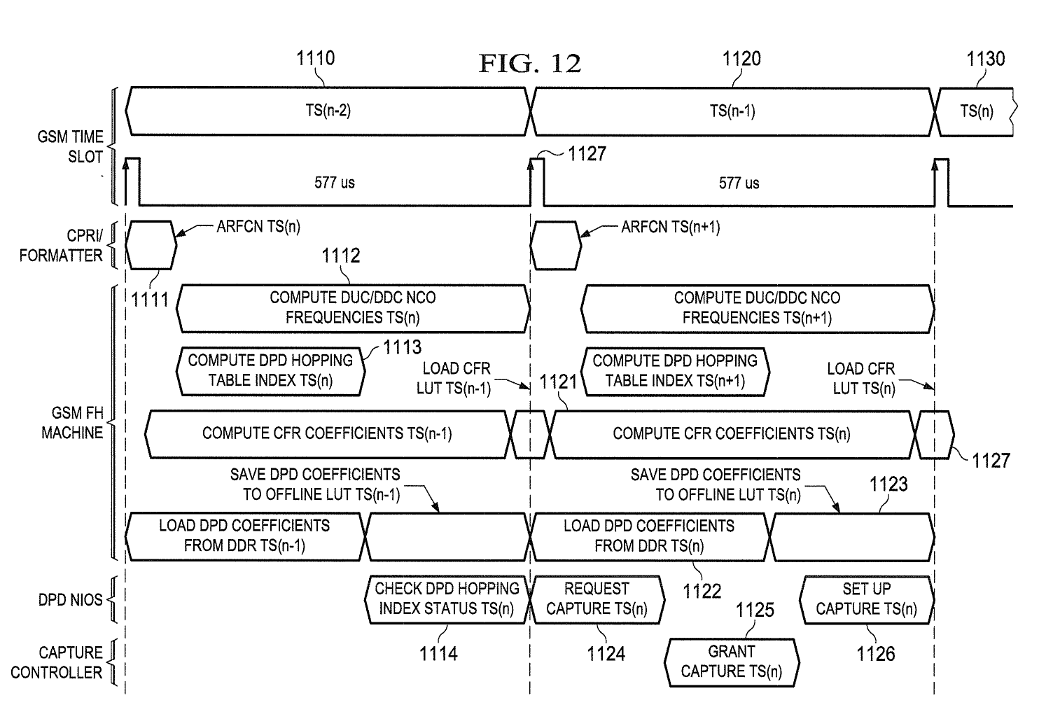

FIGS. 11 and 12 illustrate a timing diagram the complex system within a transceiver according to embodiments of the present disclosure. FIG. 11 illustrates a high level timing diagram. FIG. 12 illustrates a detailed timing diagram of FIG. 11. The critical timing and interaction between the various processes and hardware blocks is shown in FIGS. 11 and 12 as a further explanation of embodiments of the present disclosure. In the system within the GSM RRH transceiver 800, each GSM time slot (TS) is 577 μs long. The GSM RRH transceiver 800 is configured to frequency hop every time slot (577 μs), and as a result, the RTHW processor operates within the bounds of each time slot. The timeslot “TS (n−2)” represents the timeslot that is two timeslots earlier than TS(n); one time slot early is shown as “TS (n−1),” and a current timeslot is shown as “TS (n).”

During a first timeslot 1110, the GSM frequency hop information is sent through the CPRI link 897 two timeslots early—meaning within approximately 1.14 milliseconds (ms). That is, in block 1111, the CPRI's 895 formatter 897 sends to the TSM 1032 the ARFCN frequency information corresponding to timeslot TS(n) two time slots early, during TS(n−2) 1110. The TSM 1032 receives the ARFCN information for up to eight GSM carriers. The TSM 1032 sends timing block data 1005 to a portion of the RTHW processor, such as the first state machine 1034. The RTHW processor 730 computes the index for the specific hop along with the NCO phase increments for the DUC 750 and DDC 770. For example, in block 1112, the first state machine 1034 computes the NCO frequencies for the DUC 750 and DDC 770 for TS(n). In block 1113, the second state machine 1036 computes the DPD hopping table index for TS(n). In block 1114, the DPD NIOS 820 checks the DPD hopping index status for the specific hop, TS(n).

During a second timeslot 1120, one timeslot early, the RTHW processor determines the frequency configuration, computes a hopping index, computes the particular parameters, such as NCO phase increment and CFR pulse filter coefficients, and also configures the hardware blocks 750, 760, 770, 780 to be ready to operate on the new configuration at the beginning of a third timeslot 1130, namely, a current timeslot TS(n). For example, in block 1121, the first state machine 1032 computes the CFR coefficients for TS(n). During the second timeslot, in block 1122, the second machine 1036 in the HW processor computes the CFR filter coefficients and fetches the look up table information for a specific hop. The second state machine 1036 loads the DPD coefficients from the DDR 1015 for TS(n). In block 1123, the second state machine 1036 saves the DPD coefficients to the Offline LUT for TS(n). In block 1124, the DPS NIOS820 requests capture information for TS(n). In response to receiving the request for capture information in block 1125, the capture controller 890 grants capture information to the DPD NIOS 820 for TS(n). After receiving the granted capture information in block 1126, the DPD NIOS 820 sets up capture for TS(n). Also during the second timeslot 1120, the GSM frequency hop information is sent through the CPRI link 897 for a fourth timeslot TS(n+1).

Before the beginning of TS(n) 1130, each of these parameters is loaded into the DSP blocks 750, 760, 770, and 780 during the 35 μs of dead time 1127 that exists between each time slot transmission. During the third timeslot 1130, the GSM frequency hop information is sent through the CPRI link 897 for a fifth timeslot TS(n+2). The RTHW processor determines the frequency configuration, computes a hopping index, computes the particular parameters, such as NCO phase increment and CFR pulse filter coefficients, and also configures the hardware blocks 750, 760, 770, 780 to be ready to operate on the new configuration at the beginning of the fourth timeslot TS(n+1).

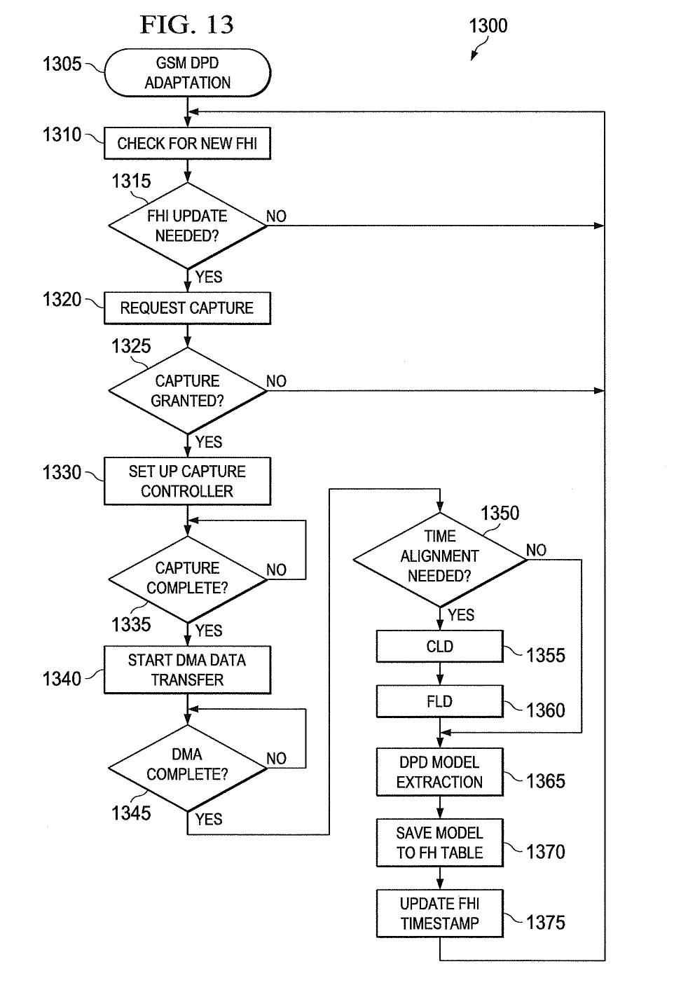

FIG. 13 illustrates a high level process 1300 flow implemented by the DPD NIOS 820 (also referred to as “DPD processor”) according to embodiments of the present disclosure. The NPD NIOS 820 is not required to perform all of the operations that are performed in the real time HW processor 830, as a result, the DPD NIOS 820 does not require the overhead and complexity of a real time operating system. The process 1300 flow for the DPD NIOS 820 can then be a simple loop, such as the example shown in FIG. 13. In certain embodiments, the DPD processor 820 monitors the frequency hopping index from the FH machine. When an index is detected that needs to be updated, the DPD processor 820 requests that the data be captured. Once capture is completed, the DPD processor 820 is notified and the data is transferred into the DPD processor 820 through a DMA 815 interface. The DPD processor 820 then computes the new solution and saves that solution at the appropriate index in memory 815, making the solution available to the GSM FH machine 830 the next time that index is detected. The DPD processor 820 according to embodiments of the present disclosure includes simplified hardware and software requirements.

At block 1305, the GSM DPD Adaptation begins. At block 1310, the DPD processor 820 checks for new frequency hop information, such as a frequency hopping index (FHI) from the GSM FH machine 830. The DPD processor 820 determines whether the FHI needs to be updated in block 1315. If the FHI needs to be updated, the DPD processor 820 sends a request to the capture system 890 in block 1320, requesting that the FHI data be captured.

In block 1325, the capture system receives the request to capture the FHI data, and determines whether or not to capture the FHI. When the capture system 890 determines that the FHI will be captured, the capture system grants the capture request, and then the process moves to block 1330 to set up the capture controller. When the capture system 890 determines that the FHI will not be captured, the capture system denies the capture request, and then the process returns to block 1310 to check for new FHI information.

In block 1335, after the capture controller is set up, the capture system 890 determines whether the requested FHI information has been captured. As long as the capture is not complete, such as when the requested FHI information has not been captured, the process returns to block 1335. Upon completion of the capture, the process moves to block 1340.

In block 1340, an adaptation processor, such as the adaptation processor 720 of the adaptation layer computes the new solution and starts to transfer that solution at an appropriate index in memory. In certain embodiments, the DPD processor 820 starts a DMA data transfer to the memory 815.

In block 1345, the DPD processor 820 determines whether the transfer of the new solution to the DMA is complete to the memory 815. When the DPD processor determines that the DMA is incomplete, the process returns to block 1345. When the DPD processor 820 determines that the DMA is complete, the process moves to block 1350 to determine whether a time alignment is needed.

In block 1350, when a time alignment is needed, the process 1300 moves to block 1355 to perform a CLD process. In block 1360, the DPD processor 820 performs a FLD process.

In block 1365, the DPD processor 820 extracts a DPD model information. In block 1370, the DPD processor saves the model to the frequency hop table in the memory 815. In block 1375, the DPD processor 820 updates the timestamp of the FHI.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless communication network, a method comprising:
generating real time timing signals for a frequency hop (FH) machine using a received ARFCN signal and received timing signal;
reconfiguring, by a real time hardware processor, a plurality of digital signal processing (DSP) blocks on a hop by hop basis,
configuring look up tables in a digital-pre-distortion (DPD) block on a hop by hop basis using the received timing signals.

2. The method as set forth in claim 1, wherein the plurality of digital signal processing (DSP) blocks comprises a crest factor reducer (CFR) comprising a composite crest factor reducer pulse shaping filter (CPSF) generator, and
wherein the method further comprises:
dynamically generating a composite pulse shaping filter (PSF) corresponding to a frequency hopping input signal received by a crest factor reducer (CFR); and
loading the composite PSF into a PSF look up table (LUT) of the CFR,
wherein dynamically generating and loading the composite PSF into the CFR PSF LUT occurs on a hop by hop basis comprising a frequency hopping period T, and
wherein loading the composite PSF into the CFR PSF LUT occurs together with loading the input signal.

3. The method as set forth in claim 2, wherein the CPSF generator comprises a numerically controlled oscillator (NCO), and
wherein the method further comprises:
receiving a specified phase offset value and specified a phase increment value,
generating a plurality of different complex frequency signals multiplexed in an alternate fashion using the specified phase offset value and the specified phase increment value.

4. The method as set forth in claim 1, further comprising:
receiving an absolute radio-frequency channel number (ARFCN) signal and a timing signal,
generating real time timing signals for the FH machine using at least one of the received ARFCN and timing signals;
reconfiguring a plurality of digital signal processing (DSP) blocks on a hop by hop basis, and
configuring look up tables in the digital-pre-distortion (DPD) block on a hop by hop basis using the received timing signals.

5. The method as set forth in claim 4, wherein reconfiguring the plurality of DSP blocks on a hop by hop basis further comprises:
computing phase values for numerically controlled oscillators in a DUC and in a DDC on a hop by hop basis, and
computing filter coefficients for a crest factor reduction block.

6. The method as set forth in claim 1, wherein the hop by hop basis comprises a frequency hop every 577 microseconds.

7. A composite crest factor reducer pulse shaping filter (CPSF) generator for use in a wireless communication system, the CPSF generator comprising:
a plurality of instructions stored in a computer-readable medium, the plurality of instructions configured to, when executed, cause processing circuitry to:
dynamically generate a composite pulse shaping filter (PSF) corresponding to a frequency hopping input signal received by a crest factor reducer (CFR); and
load the composite PSF into a PSF look up table (LUT) of the CFR,
wherein the CPSF generator is configured to dynamically generate and load the composite PSF into the CFR PSF LUT inclusively within a frequency hopping period T, and
wherein the composite PSF is loaded into the CFR PSF LUT together with the input signal.

8. The CPSF generator as set forth in claim 7, wherein the input signal comprises a number N of simultaneous frequency positions; and
wherein the composite PSF comprises a sum of N complex frequency signals.

9. The CPSF generator as set forth in claim 8, wherein sum of N complex frequency signals comprises:
a de-serialized sequence of complex signals, wherein the sequence of complex signals comprise a series of passband signals.

10. The CPSF generator as set forth in claim 9, wherein, each passband signal is generated by:
multiplying a baseband PSF signal by each complex frequency signal output by a numerically controlled oscillator (NCO), to up-convert the baseband signal to a passband signal.

11. The CPSF generator as set forth in claim 7, comprising a numerically controlled oscillator (NCO) configured to:
receive a specified phase offset value and specified a phase increment value,
generate a plurality of different complex frequency signals multiplexed in an alternate fashion using the specified phase offset value and the specified phase increment value.

12. The CPSF generator as set forth in claim 11, wherein the a phase increment look up table provides the specified a phase increment value to the NCO, and
wherein a phase offset look up table provides the specified phase offset value to the NCO.

13. A frequency hop (FH) machine for use in a wireless communication network of frequency agile signals, the frequency hop (FH) machine comprising:
a timing block configured to receive real time configuration information and generate real time timing signals for the FH machine;
a real time hardware (RTHW) processor corresponding to at least one independent antenna paths, the real time hardware processor configured to reconfigure a plurality of digital signal processing (DSP) blocks on a hop by hop basis using the received real time configuration information.

14. The FH machine as set forth in claim 13, wherein the RTHW processor comprises:
a first state machine configured to reconfigure a plurality of digital signal processing (DSP) blocks on a hop by hop basis, and
a second state machine configured to configure look up tables in the digital-pre-distortion (DPD) block on a hop by hop basis using the timing signals received from the timing block.

15. The frequency hop machine as set forth in claim 14, wherein the plurality of DSP blocks comprises a digital up converter (DUC), a digital down converter (DDC), and a crest factor reducer (CFR); and
wherein the first state machine is further configured to:
compute phase values for numerically controlled oscillators in the DUC and in the DDC on a hop by hop basis, and
compute filter coefficients for a crest factor reduction block.

16. The FH machine as set forth in claim 15, wherein the CFR comprises a composite crest factor reducer pulse shaping filter (CPSF) generator comprising:
a plurality of instructions stored in a computer-readable medium, the plurality of instructions configured to, when executed, cause processing circuitry to:
dynamically generate a composite pulse shaping filter (PSF) corresponding to a frequency hopping input signal received by a crest factor reducer (CFR); and
load the composite PSF into a PSF look up table (LUT) of the CFR,
wherein the CPSF generator is configured to dynamically generate and load the composite PSF into the CFR PSF LUT inclusively within a frequency hopping period T, and
wherein the composite PSF is loaded into the CFR PSF LUT together with the input signal.

17. The frequency hop machine as set forth in claim 13, wherein the plurality of DSP blocks comprises:
a digital up converter (DUC),
a digital down converter (DDC),
a digital pre-distorter (DPD),
and a crest factor reducer (CFR), and
a data capture.

18. The base station transceiver of claim 13, wherein the hop by hop basis comprises a frequency hop every 577 microseconds.

19. The frequency hop machine as set forth in claim 14, wherein the at least one independent antenna paths comprises two independent transmit paths and two independent receive paths.

20. The frequency hop machine as set forth in claim 14, wherein when the at least one independent antenna paths comprises an independent transmit path, the independent transmit path comprises a digital up converter (DUC), a crest factor reducer (CFR), and a DPD, and
wherein when the at least one independent antenna paths comprises an independent receive, path, each independent receive path comprises a digital down converter (DDC).

21. A transmitter comprising:
a frequency hop (FH) machine comprising:
a timing block configured to receive real time configuration information and generate real time timing signals for the FH machine;
a real time hardware (RTHW) processor corresponding to at least one independent antenna paths, the real time hardware processor configured to reconfigure a plurality of digital signal processing (DSP) blocks on a hop by hop basis using the received real time configuration information.

22. The transmitter as set forth in claim 21, wherein the transmitter further comprises:
a control processing circuitry configured to provide low speed initial configuration and setup parameters to the plurality of DSP blocks; and
an adaptation processing circuitry configured compute multiple DPD solutions and store a solution set to the RTHW processor;
wherein the control processing circuitry, the adaptation processing circuitry, and the real time hardware processor perform different functions from each other and operate independently of each other.

23. The transmitter as set forth in claim 21, wherein the plurality of DSP blocks comprises at least one CFR coupled to a a composite crest factor reducer pulse shaping filter (CPSF) generator comprising:
a plurality of instructions stored in a computer-readable medium, the plurality of instructions configured to, when executed, cause processing circuitry to:
dynamically generate a composite pulse shaping filter (PSF) corresponding to a frequency hopping input signal received by a crest factor reducer (CFR); and
load the composite PSF into a PSF look up table (LUT) of the CFR,
wherein the CPSF generator is configured to dynamically generate and load the composite PSF into the CFR PSF LUT inclusively within a frequency hopping period T, and
wherein the composite PSF is loaded into the CFR PSF LUT together with the input signal.
